(19) United States
(12) Patent Application Publication
(10) Pub. No.: US 2010/0140289 A1
(43) Pub. Date: Jun. 10, 2010

(54) DEVICE AND METHOD FOR DOSING FOAMED COMPOUNDS

(75) Inventors: Alex Knobel, Dubendorf (CH); Daniel Walt, Matzingen (CH)

Correspondence Address: LERNER GREENBERG STEMER LLP, P O BOX 2480, HOLLYWOOD, FL, 33022-2480, US

(73) Assignee: HAAS-MONDOMIX B.V., Almere (NL)

(21) Appl. No.: 12/524,657

(22) PCT Filed: Jan. 22, 2008
(86) PCT No.: PCT/EP08/00447

§ 371 Date: Feb. 22, 2010

(30) Foreign Application Priority Data
Jan. 26, 2007 (CH) 0125/07

(51) Int. Cl. B67D 7/70; G01F 11/20

(52) U.S. Cl. 222/1; 222/255; 222/135

(57) ABSTRACT

A device and a method for dosing compounds and especially foamed compounds to a dosage target location. The device has at least one unit with respective pumps and nozzles that are fluidically interconnected. The pump is a rotary pump with at least one rotary element arranged to rotate inside a pump chamber.

### SUBJECT-MATTER AND/OR TECHNICAL FIELD

The invention relates to a device and a method for dosing foamed compounds. A device of this type is, for example, used in the manufacture of a consumable product, in particular for filling and free-finishing foamed, pressurized compounds. Generally, the foamed compounds to be dosed are viscous compounds from the field of food products, adhesives, insulants, etc. which, in the dissolved, melted or softened state, have been foamed up with a gas and are dosed to a target location via a pump and nozzle system and subsequently harden.

### ACCOUNT OF THE INVENTION

### Prior Art

In known filling systems, the filling amount of compounds of this type is filled or free-finished in a time-controlled manner via open/close valves or via ram dosing pumps. The compound is supplied to a container (collector), which is embodied in a compression-proof manner, generally via one to two pressure lines.

### Drawbacks

On the one hand, ram dosing pumps do not provide the required speed; on the other hand, the foamed-up compound expands between the dosing ram and the nozzle outlet. This has the consequence that the compound drips at the nozzle outlet and the filling precision is reduced. During dosing by means of time-controlled valves, the flow conditions in the container, which is embodied in a compression-proof manner, do not permit a precisely defined pressure over the entire system up to the nozzle outlets. This also results in imprecision in the filling volume. Furthermore, withdrawal, and thus a precisely defined break-off, of the compound is not possible.

### Problem

The problem of the present invention is to develop a dosing device and especially a pump system in order to improve filling precision, to increase the speed of the pumping process and the entire filling/finishing process, to prevent dripping at the nozzle outlet and to ensure clean breaking-off of the dosed compound.

### Solution

The problem is solved, in terms of the device, by the features of claim 1 and, in terms of the method, by the features of claim 10.

### Advantages

Advantageous developments emerge from the dependent patent claims. The advantage of the invention consists in the fact that the predefined pressure in the compound can be kept constant up to the nozzle outlets. The filling precision is increased as a result of the supplying of each (retractably closable) nozzle with a pump and the synchronization of all the pumps. The use of a rotary ram pump, a gear pump or the like obviates the need for an intake stroke which is necessary in ram dosing pumps and increases the overall cycle time. An advantage of the invention results from the use of rotary pumps which are coupled to one another and jointly form a pump unit. This produces exactly the same amount of compound (for example foamed consumable product) for each nozzle. The rotary pumps are supplied with free-flowing compound via a compression-proof container.

A further advantage of the invention results from the use of a slip clutch which mechanically, electromechanically or magnetically connects the drive motor to the pump unit. The drive motor can also be fixedly connected to the pump unit. In this case, the torque is controlled electronically. It is also possible to use an air or hydraulic motor and to set the torque via the air or oil pressure. The torque at the pump unit is set in such a way that, during and after the flowing-out process, the required pressure in the compound is kept constant up to the nozzle outlet. This prevents the compound from expanding before the nozzle outlet.

A further advantage of the invention results from the use of pull-back rams which are integrated in the closure mechanisms of the nozzles and prevent the compound from dripping after the filling and finishing process. Once the nozzles are closed, the pull-back rams are pulled back in synchronization. As a result, a portion of the compound remaining in the nozzle outlet is drawn into the cylinder space of the pull-back ram and clean breaking-off of the compound without dripping is ensured.

### LIST OF FIGURES/DRAWINGS

The invention will be described in greater detail based on an exemplary embodiment which is to be interpreted in a non-restrictive manner and is illustrated in the drawings, in which:

FIG. 1A is a side view of a portion of a dosing system or pump system according to the invention comprising a plurality of units which are connected in parallel and each have a rotary ram pump, a nozzle and a closure mechanism with a pull-back ram;

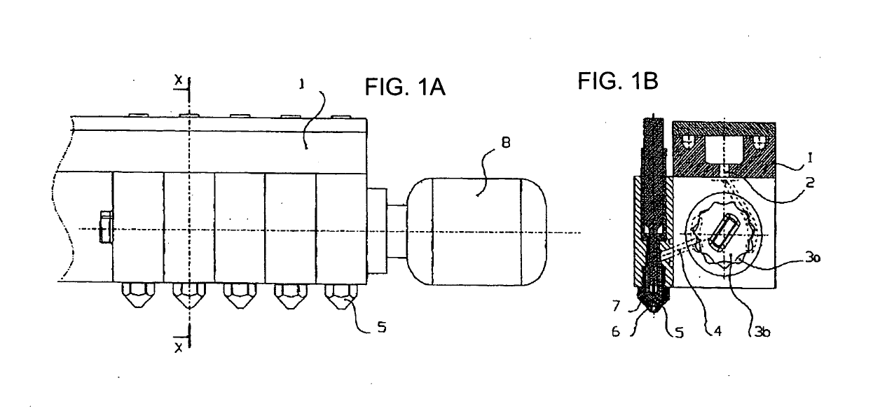

FIG. 1B is a sectional view along the plane X-X in FIG. 1A through one of the units of FIG. 1A;

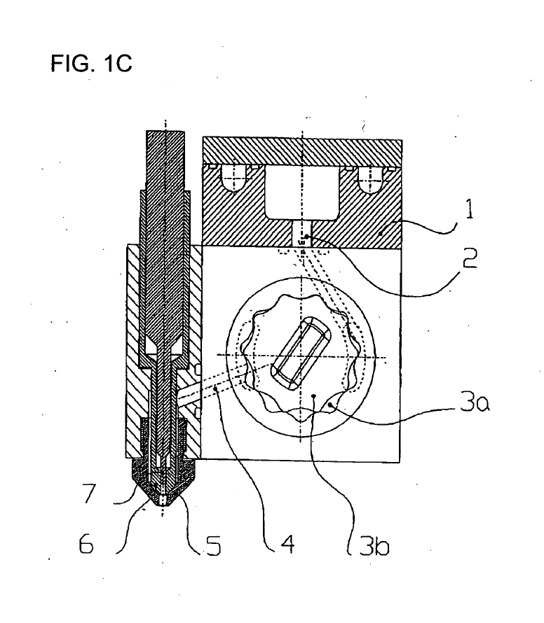

FIG. 1C is an enlarged illustration of the sectional view of FIG. 1B;

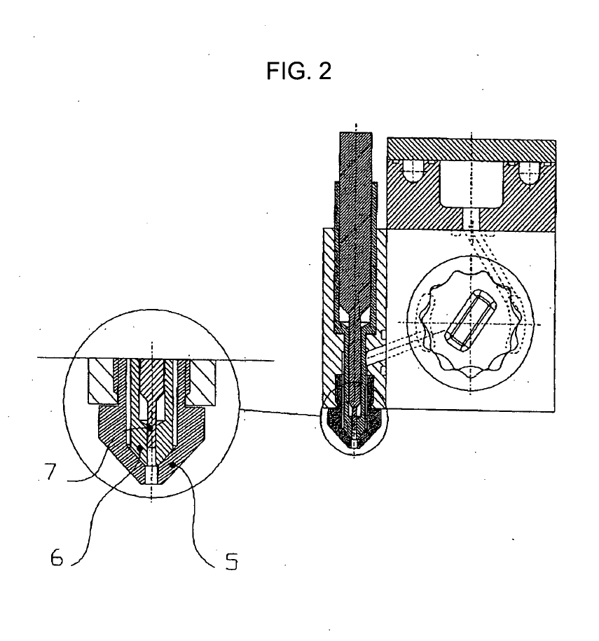

FIG. 2 shows a state prior to the dosing step of the filling and finishing process with the nozzle outlet closed (or just opening) and the pull-back ram in the upper position;

FIG. 3 shows a state during the dosing step of the filling and finishing process with the nozzle outlet opened and the pull-back ram in the lower position (zero position); and

FIG. 4 shows a state after the dosing step of the filling and finishing process with the nozzle outlet closed (or just closing) and the pull-back ram on its way back to the upper position.

### CARRYING-OUT OF THE INVENTION

In a device for making a consumable product from a free-flowing, especially foamed compound, for example a consumable confectionery product, the free-flowing compound is located in a container (1) which is preferably embodied in a compression-proof manner and the outlets (2) of which open into intercoupled rotary ram pumps (3). The volume flow is synchronized as a result of the coupling of the rotary ram pumps (3). The outlets (4) of the rotary ram pumps open into nozzles (5), before the outlet openings of which a respective closure mechanism (6) is located. The closure mechanisms (6) are opened in synchronization during a defined time window. In this way, the compound can be dosed in an exact manner. Each closure mechanism (6) is provided with a pull-back ram (7) which allows, when the closure mechanism (6) is closed, a portion of the compound located in the nozzle outlet to be withdrawn. This prevents dripping and ensures clean breaking-off of the compound. The torque which the drive (8) exerts on the rotary ram pumps (3) can be continuously adjusted in such a way that, during the flowing-out process, the predefined pressure in the compound is maintained up to the nozzles (5).

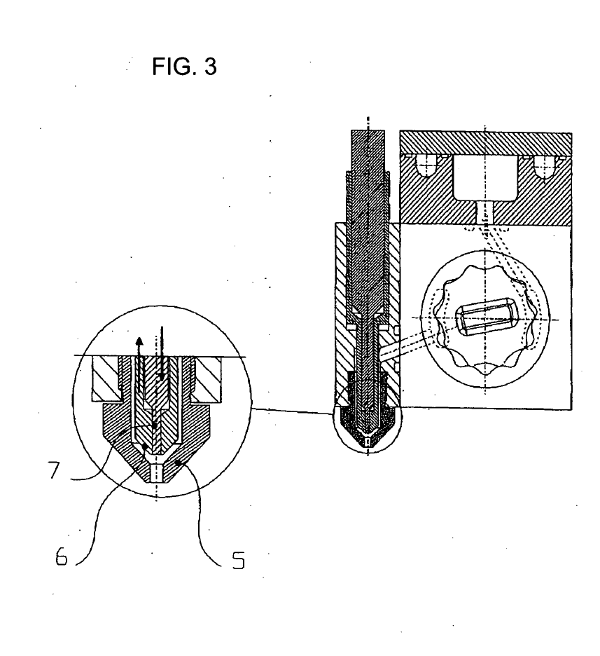

FIG. 2 shows a starting position of the filling/finishing process with the nozzle outlet closed and the pull-back ram in the upper position.

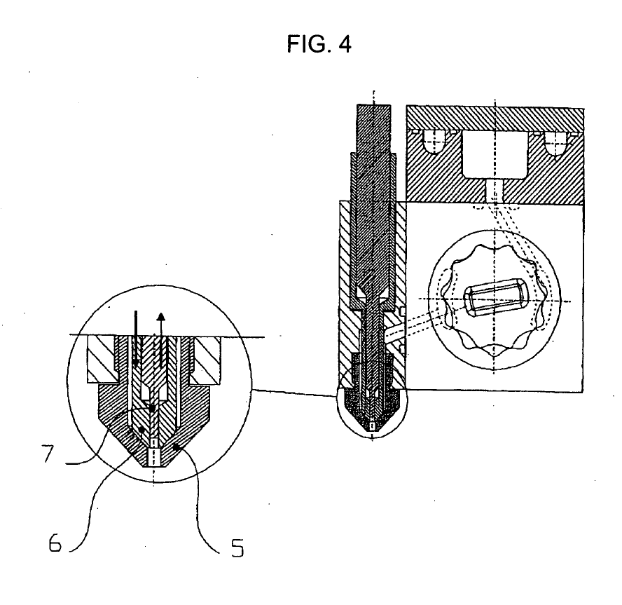

FIG. 3 shows the opened nozzle outlet and the pull-back ram at the bottom in the zero position. The filling and finishing process is taking place.

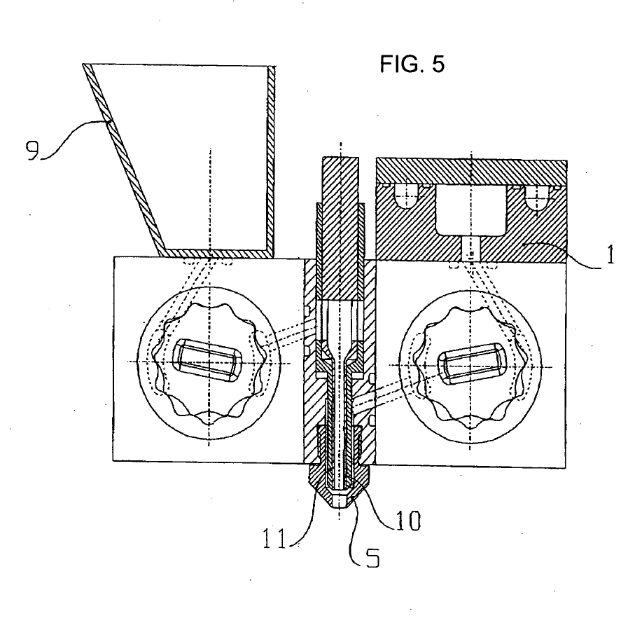

FIG. 4 shows how the nozzle outlet is closed. The pull-back ram draws a portion of the compound located in the nozzle outlet into the cylinder space of the pull-back ram as a function of the pull-back path set, as a result of which the compound breaks off.

### REFERENCE NUMERALS

1 Compression-proof container (collector)
2 Outlet channel to the pump
3 Rotary ram pump
3a Pump chamber
3b Rotary element
4 Outlet channel to the nozzle
5 Nozzles
6 Closure mechanism
7 Pull-back ram
8 Drive motor
9 One-shot storage container
10 One-shot inner nozzle tube
11 One-shot closure ram

1-15. (canceled)

16. A device for dosing compounds to a dosage target location, the device comprising:
at least one unit having a pump and a nozzle fluidically connected to said pump;
said pump being a rotary pump with at least one rotary element rotatably disposed in a pump chamber.

17. The device according to claim 16, which comprises a drive motor connected to said at least one unit.

18. The device according to claim 17, wherein said drive motor is connected to said at least one unit via a non-rigid connection for transmitting a torque to said rotary element.

19. The device according to claim 17, wherein said drive motor is configured to have a controllable rotational speed and a controllable torque.

20. The device according to claim 16, wherein said at least one unit is one of a plurality of units connected in parallel and having said rotary pumps coupled to one another.

21. The device according to claim 16, which comprises a drive motor connected to said plurality of intercoupled units.

22. The device according to claim 18, wherein said drive motor is connected to said plurality of intercoupled units via a non-rigid connection for transmitting a torque to said rotary elements.

23. The device according to claim 16, wherein said nozzle includes a closure mechanism.

24. The device according to claim 23, wherein said closure mechanism comprises a pull-back ram disposed in said nozzle and displaceably mounted with respect to a nozzle outlet.

25. The device according to claim 23, wherein said at least one unit is one of a plurality of units connected in series and wherein said closure mechanisms of the respective said nozzles are coupled to one another.

26. The device according to claim 20 in combination with a conveying unit for transporting articles disposed next to one another and parallel to one another along parallel transport paths, wherein said units that are connected in parallel with one another are arranged in a transverse direction relative to the transport path such that the dosage target location of each unit is a respective article on a respective said transport path.

27. The device according to claim 16 configured for dosing foamed compounds.

28. A method for dosing foamed compounds to a target location, the method which comprises:
providing a device according to claim 16;
driving a rotary pump by supplying a torque to a rotary element of the rotary pump and pressurizing the foamed compound;
placing the units at respective dosage target locations thereof;
opening the nozzles when the units are located at their dosage target location, such that the foamed compound issues from the nozzles and reaches the respective dosage target location; and
subsequently closing the nozzles.

29. The method according to claim 28, which comprises controlling the torque and/or a rotational speed of a drive during the driving of the rotary pump.

30. The method according to claim 28, wherein the step of closing each of the nozzles comprises pulling back a pull-back ram back into the nozzle.

31. The method according to claim 28, wherein the placing step comprises moving the units and the dosage target location relative to one another.

32. The method according to claim 31, wherein the placing step comprises bringing the units up to their respective dosage target location by moving the units and/or moving the dosage target location.

33. The method according to claim 31, wherein the dosage target locations are defined on articles that are arranged next to one another and transported parallel to one another along a transport path.

34. The device according to claim 16, wherein said at least one unit is one of a plurality of units with two or more series of pumps, and the device is configured to produce two or more different compounds in one operation by said two or more series of pumps by way of an inner nozzle tube and a closure ram controlling an amount of foamed compound.

35. The device according to claim 34, configured to produce one-shot products with at least one foamed compound and one non-foamed compound.
